(19) United States
(12) Patent Application Publication
(10) Pub. No.: US 2025/0285604 A1
(43) Pub. Date: Sep. 11, 2025

(54) STRING LOCKING TREMOLO BRIDGE BLOCK AND ATTACHMENT

(71) Applicant: David Michael Spinnazola, Greenbank, WA (US)

(72) Inventor: David Michael Spinnazola, Greenbank, WA (US)

(21) Appl. No.: 18/601,623

(22) Filed: Mar. 11, 2024

(51) Int. Cl. G10D 3/153; G10D 3/04

(52) U.S. Cl. CPC G10D 3/153; G10D 3/04

(57) ABSTRACT

A locking tremolo bridge block comprising horizontally drilled and threaded holes for each string which intersect the vertical string bore passages just below the bridge plate so that screws clamp down the strings locking them in place so they cannot move, while offering tuning stability.

### CROSS-REFERENCE TO RELATED APPLICATIONS

This application claims priority to U.S. Provisional Application No. 63/489,390 filed Mar. 9, 2023, which is incorporated by reference in its entirety.

### FIELD OF THE DISCLOSURE

This disclosure relates generally to the field of musical instruments; in particular, electric guitars.

### BACKGROUND

A locking tremolo bridge block is a string locking mechanism for a guitar bridge to keep the instrument in tune.

A Fender style tremolo bridge is generally made up of the following individual components; the bridge plate which is mounted horizontally and has holes or cut outs for the fulcrum, a hole for a tremolo arm, holes for the strings to pass through into the block, a block with vertically drilled holes for each string, and saddles for each string to rest on, a vertical wall at the back to attach and adjust the saddles fore and aft, and adjustable springs which secure the bridge to the guitar body. This design of bridge was introduced by Fender Corporation in 1954.

The guitar's strings are fed into holes on the underside of the block and through the holes on the bridge plate, and rest on the saddles, stretched over the neck's fretboard, wrapped around the individual tuners on the head of the neck, and tensioned to the desired pitch. Balls on the ends of the strings secure the strings in the base of the block.

The tremolo bridge operates by using the tremolo arm as a lever to tip the bridge up or down at its pivot in order to alter the length of the strings to change the pitch of the guitar. The bridge plate and saddles sit above the surface of the guitar horizontally, the block which is attached vertically to the bridge plate sit inside a hole cut into the guitar body, and the springs which are located at the underside of the guitar body counteract the tension of the strings. Screws or studs locate the bridge assembly on the guitar body and serve as the fulcrum.

Traditionally, the main purpose of the block on a bridge is to provide an anchor point for the ends of the strings and a lever. The block is also thought to provide resonance when the guitar's strings are vibrating, and different metals of different density and mass provide different tonal characteristics. Because the strings are under tension of varying degrees and are of different gauges and bent over the saddles, the ball end can shift and alter the tuning of the guitar. This tuning instability has been going on since the introduction of tremolo bridges for guitars produced by MANY manufactures worldwide besides the Fender Stratocaster. The problem with these tremolo bridges is they go out of tune while the bridge pivots. This occurs because there are multiple places the strings can get hung up, or mechanically the tremolo mechanism sticks.

The most well-known solution to this problem was invented by Floyd Rose back in 1977. Since then, thousands of these “locking tremolo's” have been sold and even come as original equipment on many brands of guitars. The Floyd Rose solved the tuning issues because it locked the strings as the nut on the neck and on the bridge on the body. There are some who do not like the Floyd Rose because it is either too complicated or they do not want to modify their guitars to fit the Floyd Rose.

Accordingly, there is a need in the art for a device that would make it easier and more convenient to readily tune a guitar. The presently disclosed string locking tremolo bridge block and attachment device addresses these needs.

### SUMMARY

The disclosure presented herein relates to string locking tremolo block to facilitate tuning of a guitar.

The string locking tremolo block disclosed herein is a replacement for the tremolo block located on the bridge of an electric guitar. Current standard tremolo blocks connect the upper bridge horizontal plate to the horizontal pull springs located in a cavity on the under-side of the guitar. Strings pass through the length of the block in a bore vertically and are anchored in place by the ball end of the string, the other end of the string is wound around the tuner on the head of the guitar neck. The presently disclosed device clamps the strings inside the bores of the tremolo block, to aid in tuning stability during raising and lowering the pitch of the guitar using the whammy bar.

Some locking bridges do not have holes for strings to pass through. The presently disclosed device does not address that style of bridge, commonly referred to as a “Floyd Rose” or Floyd Rose Licensed Locking Bridge”.

The preceding and following embodiments and descriptions are for illustrative purposes only and are not intended to limit the scope of this disclosure. Other aspects and advantages of this disclosure will become apparent from the following detailed description.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a perspective view of an embodiment of a presently disclosed string locking tremolo block.

FIG. 2 is a front view of a tremolo assembly.

FIG. 3 is side view of a tremolo assembly.

FIG. 4 is perspective view of a locking tremolo block.

FIG. 5 is a side cutaway view of a tremolo bridge assembly.

FIG. 6 shows how a bridge plate is attached to a locking block.

FIG. 7 shows how a Fender style tremolo system works.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

For the sake of the presently disclosed device, the block plays a larger role than working as part of the fulcrum or anchor for the strings, it locks the strings into place so that not only the strings balls anchor the strings onto place, but it also clamps the strings into place just below the surface of the bridge plate.

The presently disclosed device is made up of a couple components beyond the vertically drilled holes or bores in the block. In particular, there are horizontally positioned set screws, clamping pins which engage the strings along their length, and slotted bores on the horizontal surface of the tremolo block where it is attached to the underside of the bridge plate horizontally. The slotted grooves machined into the surface of the block allow the clamping pins to engage the strings and lock them against the drilled holes/bores in the vertical axis of the strings holes/bores thereby clamping the strings securely in place into the block. As the bridge is rocked on its pivot, the strings bent over the edges of the saddles lengthen or shorten to allow for pitch changes, yet not slip and go out of tune. This provides for tuning stability, something all guitarists are appreciative of, because nobody wants to go out of tune during a song, or after using the tremolo, which can happen many times during even a single song.

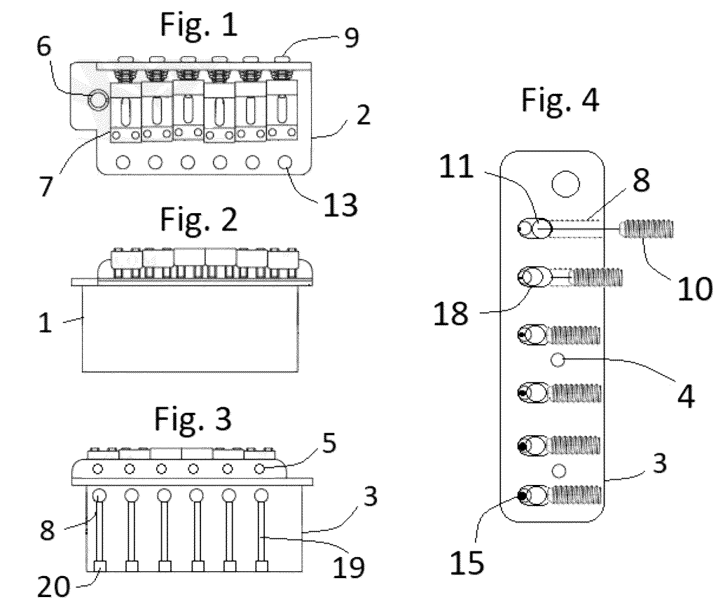

Turning now to the drawings, FIG. 1 demonstrates how the strings are bent over the saddles 7; generally anchored and routed through the block passing through the horizontal surface of the bridge plate 2 on the horizontal surface; and the saddles are adjusted using the screws 9. The tremolo arm is fed through the hole in the bridge plate 6, with the fulcrum utilizing holes in the bridge plate 13.

FIG. 2 shows a front view of the tremolo assembly 1 and thereby shows the block 3, bridge plate 2 and the saddles 7.

Turning now to FIG. 3, the string locking tremolo block 3 employs threaded holes 8 and set screws 10 and Clamping Pins 11, which intersect the path the strings take through the bores 19 in the block to lock the string in place so that it cannot slip and go out of tune. A tremolo block is generally rectangular in shape having horizontal and vertical dimensions, as well as a width. The balls of the strings are anchored in place in the ball pockets 20. The lower part of the block 3 is attached to pull springs connected to the body of the guitar and provide a counteracting force against the strings on the top surface of the guitar. An arm is used which is attached to the tremolo bridge used as a lever to help the player pivot the tremolo bridge assembly to alter the tone of the guitar. The tremolo can raise or lower the pitch of the strings.

Turning to FIG. 4, a locking tremolo block 3 employs set screws 10 in threaded horizontal holes 8 with clamping pins 11 held in place in pockets 18 which intersect the string bore. The pockets 18 are elongated or slotted so the clamping pins 11 can close on the strings 15 of various sizes and move out of the way so strings can be threaded through the bores (FIG. 3, 19) in the block 3. The clamping pins 11 act as jaws in a vise to lock the strings 15 in place in the block.

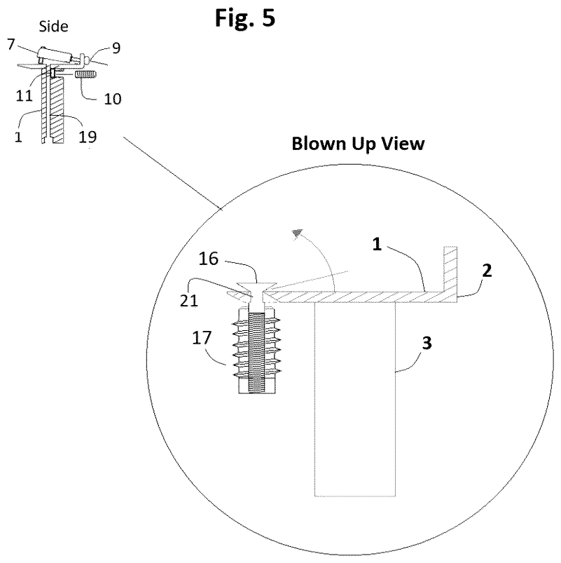

FIG. 5 shows a side cutaway view of the tremolo bridge assembly. The closer the strings are locked into place in the hole 19 in the locking block (1 in this drawing), the less string movement there is, and tuning stability can occur. The set screw 10 is tightened against the clamping pin 11 contained in the pocket (FIG. 4, 18) which clamps the string into place. After being locked into place, the string passes through a hole in the bridge plate 2 over the saddle 7 connected by screws 9, and passes over the nut, and connects to the tuners at the head end of the guitar's neck.

FIG. 5 also shows a blown-up view of another embodiment of the invention employing different screws to better secure the tremolo bridge to the guitar body. The bridge shows the bridge plate 1, with the vertical back for adjusting/securing the saddles, the locking block 3, the pivot screw 16, screw in threaded bushing 17, and the turned down knife edge groove 21.

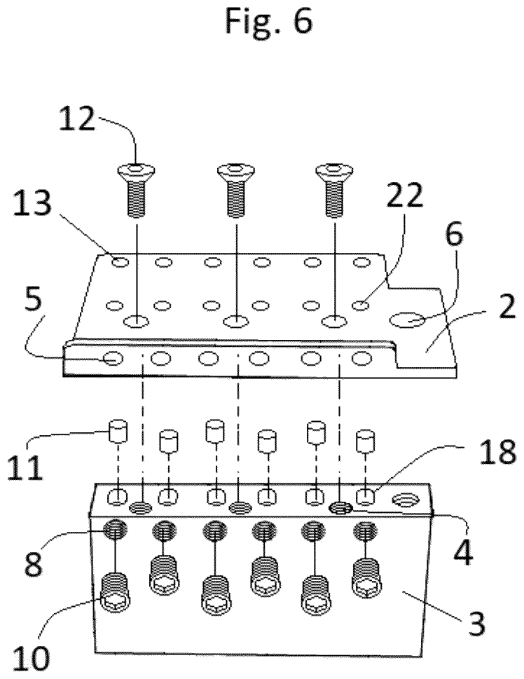

FIG. 6 shows how a bridge plate 2 is attached to the locking block 3 by screws 12 threaded into holes 4. Once assembled, strings will pass through the bores in the block (FIG. 3, 19) and are locked in place where the bores and the lock screw threaded holes 8 intersect (as mentioned in FIG. 4). The lock screws 10 push against the clamping pins 11 which are contained in pockets 18 machined into the block 3, and push against the strings.

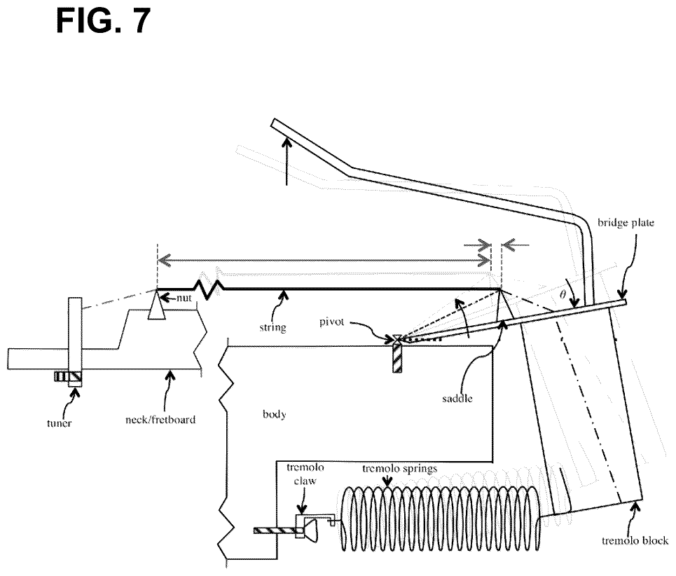

FIG. 7 shows how a Fender style tremolo system works. FIG. 7 depicts the path of a string as its anchored into a block, how it passes through a hole in the bridge plate is stretched over the fingerboard of the neck and lays on top of the nut. This drawing depicts the tremolo bridge being tilted to lower the pitch of the guitar strings, with the springs underneath stretched to counteract the tension of the strings. FIG. 7 is a general drawing as known in the art.

The following is an exemplary use of the presently disclosed device. As shown in FIG. 6, the locking tremolo block 3 will be attached to the bridge plate 2 via screws 12 on its surface, then screwed to the guitar body at the point whether it be 6 screws or 2, or more. Strings will be anchored in the locking tremolo block 3 and will pass through the holes in the bridge plate 22 in the locking tremolo block 3 and bridge plate, over the saddles, and threaded into the tuners on the head of the guitar's neck, then tuned to the correct pitch. Tipping the tremolo bridge slightly exposes the locking set screws 10 threaded into the holes 8 where they can be tightened against the clamping pins 11 which engage the strings in the intersecting bores 19 locking them into place. Note that the preferred embodiment of the device which uses clamping pins between the strings and the set screws provides more clamping surface and protects the strings from being damaged, but clamped directly to the strings functions, but can occasionally break a string, so the locking pins are superior as a clamping interface.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The exemplary, preferred embodiment was chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A locking block for a guitar tremolo bridge comprising horizontally drilled and threaded holes for each string which intersect the vertical string bore passages just below the bridge plate so that screws clamp down the strings locking them in place so they cannot move, while offering tuning stability.

2. A locking block for a guitar tremolo bridge comprising horizontally drilled and threaded holes for each string which intersect the vertical string bore passages just below the bridge plate so that screws and clamping pins clamp down the strings locking them in place so they cannot move, said horizontally drilled and threaded hole having a pocket in the path of the set screw and string passage to hold a floating clamping pin interface securely to clamp the string without damaging it, while offering tuning stability.

3. A guitar tremolo bridge comprising a multiplicity of machine screws to provide adjustment and secure the attachment of the tremolo bridge to the body of the guitar, said screws having reliefs cut into the shaft of the screw to provide smooth pivoting, said screws threaded into metallic inserts, which in turn are threaded into the body of the guitar.’

4. The guitar tremolo bridge of claim 3, the multiplicity of machine screws comprising an angular head like a countersunk screw to provide unhindered pivoting of the bridge along its horizontal axis.
